(19) United States
(12) Patent Application Publication
(10) Pub. No.: US 2009/0093544 A1
(43) Pub. Date: Apr. 9, 2009

(54) INSECTICIDAL COMPOSITIONS HAVING IMPROVED EFFECT

(75) Inventors: Rudiger Fischer, Pulheim (DE); Reiner Fischer, Monheim (DE); Christian Funke, Leichlingen (DE); Rolf Pontzen, Leichlingen (DE); Udo Reckmann, Koln (DE); Peter Marczok, Koln (DE); Christian Arnold, Langenfeld (DE); Erich Sanwald, Kiel (DE); Waltraud Hempel, Liederbach (DE)

Correspondence Address: Baker Donelson Bearman, Caldwell & Berkowitz, PC, 555 Eleventh Street, NW, Sixth Floor, Washington, DC, 20004, US

(73) Assignee: Bayer CropScience AG, Monheim (DE)

(21) Appl. No.: 12/096,177

(22) PCT Filed: Nov. 29, 2006
(86) PCT No.: PCT/EP2006/011441

§ 371 Date: Nov. 10, 2008

(30) Foreign Application Priority Data
Dec. 13, 2005 (DE) 10 2005 059 467.0

(51) Int. Cl. A01N 37/18; A01N 37/10; A01P 7/04

(52) U.S. Cl. 514/568; 514/616

(57) ABSTRACT

The present invention relates to the increase of the action of crop protection agents containing certain phthalic acid diamides by the addition of ammonium salts and/or phosphonium salts or by the addition of ammonium or phosphonium salts and penetration promoters, the corresponding agents, processes for their preparation and their use in crop protection.

The present invention relates to the increase of the action of crop protection agents containing phthalic acid diamides by the addition of ammonium or phosphonium salts and optionally penetration promoters, the corresponding agents, processes for their preparation and their use in crop protection.

It is already known that compounds of the formula (I)

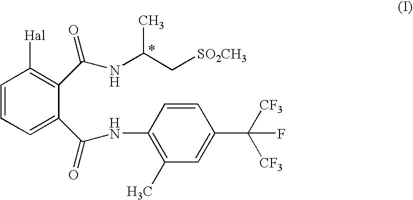

in which
Hal represents chlorine, bromine or iodine,
* characterizes a carbon atom in the R- or the S-configuration, preferably in the S-configuration,

have an insecticidal action. This is true for the racemic form of the compounds (EP-A 1 006 107) and to an even greater extent for the (S)-configured enantiomers (WO 06/22225). Specifically, the compounds (Ia), (Ib) and (Ic) may be mentioned.

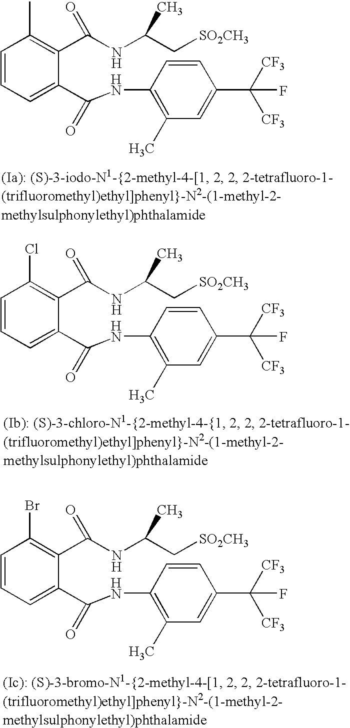

The activity of these compounds is good but nevertheless unsatisfactory in some cases.

All compounds according to the invention are already known as agents for controlling animal pests, in particular insects, and can be prepared by processes described in the prior art. The activity of these compounds is good but not always completely satisfactory, particularly when small amounts are used and in low concentrations. There is therefore a need for increasing the action of the crop protection agents containing the compounds.

The active ingredients can be used in a wide concentration range in the compositions according to the invention. The concentration of the active ingredients in the formulation is usually 0.1-50% by weight.

The possibility of increasing the action of various active ingredients by addition of ammonium or phosphonium salts has already been described in the literature. However, these are salts which act as detergents (e.g. WO 95/017817) or salts having relatively long alkyl and/or aryl substituents which have a permeabilizing effect or increase the solubility of the active ingredient (e.g. EP-A 0 453 086, EP-A 0 664 081, FR-A 2 600 494, U.S. Pat. No. 4,844,734, U.S. Pat. No. 5,462,912, U.S. Pat. No. 5,538,937, US-A 03/0224939, US-A 05/0009880, US-A 05/0096386). Furthermore, the prior art describes the action only for certain active ingredients and/or certain applications of the corresponding agents. In yet other cases, salts of sulphonic acids where the acids themselves have a paralysing effect on insects are involved (U.S. Pat. No. 2,842,476). An increase in action by ammonium sulphate is described for the herbicides glyphosate and phosphinothricin (U.S. Pat. No. 6,645,914, EP-A 0 036 106). A corresponding action in the case of insecticides is neither disclosed nor suggested by this prior art.

The use of ammonium sulphate as a formulating auxiliary is also described for certain active ingredients and applications (WO 92/16108); however, it serves there for stabilizing formulation and not for increasing the action.

It has now completely surprisingly been found that the action of insecticidal phthalic acid diamides according to the invention can be substantially increased by the addition of ammonium and/or phosphonium salts to the solution used (Tankmix application) or by the incorporation of these salts into a formulation containing such insecticides. The present invention therefore relates to the use of ammonium and/or phosphonium salts for increasing the action of crop protection agents which contain insecticidal phthalic acid diamides as active ingredient. The invention also relates to agents which contain such insecticides and ammonium and/or phosphonium salts increasing the action, and in particular to both formulated active ingredients and ready-to-use agents (spray liquors). The invention finally furthermore relates to the use of these agents for controlling insect pests.

Ammonium and phosphonium salts which according to the invention increase the action of crop protection agents containing phthalic acid diamides are defined by the formula (II)

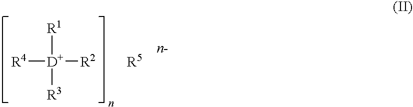

in which

D represents nitrogen or phosphorus,

D preferably represents nitrogen,

R¹, R², R³ and R⁴, independently of one another, represent hydrogen or in each case optionally substituted C₁-C₈-alkyl or mono- or polyunsaturated, optionally substituted C₁-C₈-alkylene, it being possible for the substituents to be selected from halogen, nitro and cyano,

R¹, R², R³ and R⁴, independently of one another, preferably represent hydrogen or in each case optionally substituted C₁-C₄-alkyl, it being possible for the substituents to be selected from halogen, nitro and cyano,

R¹, R², R³ and R⁴, independently of one another, particularly preferably represent hydrogen, methyl, ethyl, n-propyl, isopropyl, n-butyl, isobutyl, sec-butyl or tert-butyl,

R¹, R², R³ and R⁴ very particularly preferably represent hydrogen,

R¹, R², R³ and R⁴ furthermore very particularly preferably simultaneously represent methyl or simultaneously represent ethyl,

n represents 1, 2, 3 or 4,

n preferably represents 1 or 2,

R⁵ represents an inorganic or organic anion,

R⁵ preferably represents bicarbonate, tetraborate, fluoride, bromide, iodide, chloride, monohydrogen phosphate, dihydrogen phosphate, hydrogen sulphate, tartrate, sulphate, nitrate, thiosulphate, thiocyanate, formate, lactate, acetate, propionate, butyrate, pentanoate, citrate or oxalate,

R⁵ furthermore preferably represents carbonate, pentaborate, sulphite, benzoate, hydrogen oxalate, hydrogen citrate, methyl sulphate or tetrafluoroborate,

R⁵ particularly preferably represents lactate, sulphate, nitrate, thiosulphate, thiocyanate, citrate, oxalate or formate,

R⁵ also particularly preferably represents monohydrogen phosphate or dihydrogen phosphate and

R⁵ very particularly preferably represents sulphate.

The ammonium and phosphonium salts of the formula (II) can be used in a wide concentration range for increasing the action of crop protection agents containing ketoenols. In general the ammonium or phosphonium salts are used in ready-to-use crop protection agents in a concentration of 0.5 to 80 mmol/l, preferably 0.75 to 37.5 mmol/l, particularly preferably 1.5 to 25 mmol/l. In the case of a formulated product, the ammonium and/or phosphonium salt concentration in the formulation is chosen so that, after dilution of the formulation to the desired active ingredient concentration, it is in these stated general, preferred or particularly preferred ranges. The concentration of the salt in the formulation is usually 1-50% by weight.

In a preferred embodiment of the invention, not only an ammonium and/or phosphonium salt but additionally a penetration promoter is added to the crop protection agents for increasing the action. It is to be regarded as completely surprising that even in these cases an even further increase in action is observable. The present invention therefore likewise relates to the use of a combination of penetration promoter and ammonium and/or phosphonium salts for increasing the action of crop protection agents which contain insecticidal phthalic acid diamides as active ingredient. The invention likewise relates to agents which contain insecticidal phthalic acid diamides, penetration promoter and ammonium and/or phosphonium salts, and in particular both formulated active ingredients and ready-to-use agents (spray liquors). The invention finally furthermore relates to the use of these agents for controlling insect pests.

Suitable penetration promoters in the present context are all those substances which are usually used for improving the penetration of agrochemical active ingredients into plants. In this context, penetration promoters are defined in that they penetrate from the aqueous spray liquor and/or from the spray coating into the cuticle of the plant and can thus increase the mobility of active ingredients in the cuticle. The method described in the literature (Baur et al., 1997, Pesticide Science 51, 131-152) can be used for determining this property.

Suitable penetration promoters are, for example, alkanol alkoxylates. Penetration promoters according to the invention are alkanol alkoxylates of the formula

R—O—(-AO)ᵥ—R′ (III)

in which
R represents straight-chain or branched alkyl having 4 to 20 carbon atoms,
R′ represents hydrogen, methyl, ethyl, n-propyl, isopropyl, n-butyl, isobutyl, tert-butyl, n-pentyl or n-hexyl,
AO represents an ethylene oxide radical, a propylene oxide radical, a butylene oxide radical or mixtures of ethylene oxide and propylene oxide radicals or butylene oxide radicals and
v represents numbers from 2 to 30.

A preferred group of penetration promoters comprises alkanol alkoxylates of the formula

R—O—(-EO—)ₙ—R′ (III-a)

in which
R has the abovementioned meaning,
R′ has the abovementioned meaning,
EO represents —CH₂—CH₂—O— and
n represents numbers from 2 to 20.

A further preferred group of penetration promoters comprises alkanol alkoxylates of the formula

R—O—(-EO—)ₚ—(—PO—)_{q}—R′ (III-b)

in which
R has the abovementioned meaning,
R′ has the abovementioned meaning,
EO represents —CH₂—CH₂—O—,
PO represents

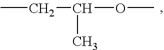

p represents numbers from 1 to 10 and
q represents numbers from 1 to 10.

A further preferred group of penetration promoters comprises alkanol alkoxylates of the formula

R—O—(—PO—)ᵣ—(EO—)ₛ—R′ (III-c)

in which
R has the abovementioned meaning,
R′ has the abovementioned meaning,
EO represents —CH₂—CH₂—O—,
PO represents

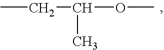

r represents numbers from 1 to 10 and
s represents numbers from 1 to 10.

A further preferred group of penetration promoters comprises alkanol alkoxylates of the formula

R—O—(-EO—)ₚ—(—BO—)_{q}—R′ (III-d)

in which
R and R′ have the abovementioned meanings,
EO represents CH₂—CH₂—O—,
BO represents

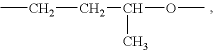

p represents numbers from 1 to 10 and
q represents numbers from 1 to 10.

A further preferred group of penetration promoters comprises alkanol alkoxylates of the formula

R—O—(—BO—)ᵣ—(-EO—)ₛ—R′ (III-e)

in which
R and R′ have the abovementioned meanings,
BO represents

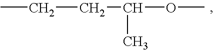

EO represents CH₂—CH₂—O—,
r represents numbers from 1 to 10 and
s represents numbers from 1 to 10.

A further preferred group of penetration promoters comprises alkanol alkoxylates of the formula

CH₃—(CH₂)ₜ—CH₂—O—(—CH₂—CH₂—O—)ᵤ—R′ (III-f)

in which
R′ has the abovementioned meaning,
t represents numbers from 8 to 13 and
u represents numbers from 6 to 17.

In the abovementioned formulae,

R preferably represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl.

As an example of an alkanol alkoxylate of the formula (III-c) 2-ethylhexyl alkoxylate of the formula

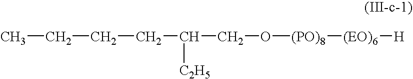

in which
EO represents —CH₂—CH₂—O—,
PO represents

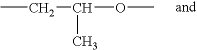

the numbers 8 and 6 represent average values, may be mentioned.

The formula

CH₃—(CH₂)₁₀—O—(-EO—)₆—(—BO—)₂—CH₃ (III-d-1)

in which
EO represents CH₂—CH₂—O—,
BO represents

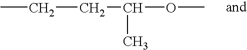

the numbers 10, 6 and 2 represent average values, may be mentioned as an example of an alkanol alkoxylate of the formula (III-d).

Particularly preferred alkanol alkoxylates of the formula (III-f) are compounds of this formula in which
t represents numbers from 9 to 12 and
u represents numbers from 7 to 9.

An alkanol alkoxylate of the formula (III-f-1)

CH₃—(CH₂)ₜ—CH₂—O—(—CH₂—CH₂—O—)ᵤ—H (III-f-1)

in which
t represents the average value 10.5 and
u represents the average value 8.4,

may be very particularly preferably mentioned.

The alkanol alkoxylates are defined in general by the above formulae. These substances are mixtures of substances of the stated type having different chain lengths. The calculated indices are therefore average values which may also differ from integers.

The alkanol alkoxylates of said formulae are known and some of them are commercially available or can be prepared by known methods (cf. WO 98-35 553, WO 00-35 278 and EP-A 0 681 865).

Suitable penetration promoters are, for example, also substances which promote the solubility of the compounds of the formula (I) in the spray coating. These include, for example, mineral or vegetable oils. Suitable oils are all mineral or vegetable—optionally modified—oils which can usually be used in agrochemical agents. Sunflower oil, rapeseed oil, olive oil, castor oil, colza oil, maize kernel oil, cottonseed oil and soybean oil or the esters of said oils may be mentioned by way of example. Rapeseed oil, sunflower oil and the methyl or ethyl esters thereof are preferred.

The concentration of penetration promoter may be varied in a wide range in the agents according to the invention. In a formulated crop protection agent, it is in general 1 to 95% by weight, preferably 1 to 55% by weight, particularly preferably 15-40% by weight. In the ready-to-use agents (spray liquors), the concentrations are in general between 0.1 and 10 g/l, preferably between 0.5 and 5 g/l.

Combinations of active ingredient, salt and penetration promoter which are to be singled out according to the invention are mentioned in the following table. “According to test” means that each compound which acts as a penetration promoter in the test for the cuticle penetration (Baur et al., 1997, Pesticide Science 51, 131-152) is suitable.

| | Active | | Penetration |
|---|---|---|---|
| # | ingredient | Salt | promoter |
| 1 | (Ia) | Ammonium sulphate | According to test |
| 2 | (Ia) | Ammonium lactate | According to test |
| 3 | (Ia) | Ammonium nitrate | According to test |
| 4 | (Ia) | Ammonium thiosulphate | According to test |
| 5 | (Ia) | Ammonium thiocyanate | According to test |
| 6 | (Ia) | Ammonium citrate | According to test |
| 7 | (Ia) | Ammonium oxalate | According to test |
| 8 | (Ia) | Ammonium formate | According to test |
| 9 | (Ia) | Ammonium hydrogen phosphate | According to test |
| 10 | (Ia) | Ammonium dihydrogen phosphate | According to test |
| 11 | (Ia) | Ammonium carbonate | According to test |
| 12 | (Ia) | Ammonium benzoate | According to test |
| 13 | (Ia) | Ammonium sulphite | According to test |
| 14 | (Ia) | Ammonium benzoate | According to test |
| 15 | (Ia) | Ammonium hydrogen oxalate | According to test |
| 16 | (Ia) | Ammonium hydrogen citrate | According to test |
| 17 | (Ia) | Tetramethylammonium sulphate | According to test |
| 18 | (Ia) | Tetramethylammonium lactate | According to test |
| 19 | (Ia) | Tetramethylammonium nitrate | According to test |
| 20 | (Ia) | Tetramethylammonium | According to test |
| | | thiosulphate | |
| 21 | (Ia) | Tetramethylammonium thiocyanate | According to test |
| 22 | (Ia) | Tetramethylammonium citrate | According to test |
| 23 | (Ia) | Tetramethylammonium oxalate | According to test |
| 24 | (Ia) | Tetramethylammonium formate | According to test |
| 25 | (Ia) | Tetramethylammonium hydrogen | According to test |
| | | phosphate | |
| 26 | (Ia) | Tetramethylammonium dihydrogen | According to test |
| | | phosphate | |
| 27 | (Ia) | Tetraethylammonium sulphate | According to test |
| 28 | (Ia) | Tetraethylammonium lactate | According to test |
| 29 | (Ia) | Tetraethylammonium nitrate | According to test |
| 30 | (Ia) | Tetraethylammonium | According to test |
| | | thiosulphate | |
| 31 | (Ia) | Tetraethylammonium thiocyanate | According to test |
| 32 | (Ia) | Tetraethylammonium citrate | According to test |
| 33 | (Ia) | Tetraethylammonium oxalate | According to test |
| 34 | (Ia) | Tetraethylammonium formate | According to test |
| 35 | (Ia) | Tetraethylammonium hydrogen | According to test |
| | | phosphate | |
| 36 | (Ia) | Tetraethylammonium dihydrogen | According to test |
| | | phosphate | |
| 37 | (Ib) | Ammonium sulphate | According to test |
| 38 | (Ib) | Ammonium lactate | According to test |
| 39 | (Ib) | Ammonium nitrate | According to test |
| 40 | (Ib) | Ammonium thiosulphate | According to test |
| 41 | (Ib) | Ammonium thiocyanate | According to test |
| 42 | (Ib) | Ammonium citrate | According to test |
| 43 | (Ib) | Ammonium oxalate | According to test |
| 44 | (Ib) | Ammonium formate | According to test |
| 45 | (Ib) | Ammonium hydrogen phosphate | According to test |
| 46 | (Ib) | Ammonium dihydrogen phosphate | According to test |
| 47 | (Ib) | Ammonium carbonate | According to test |
| 48 | (Ib) | Ammonium benzoate | According to test |
| 49 | (Ib) | Ammonium sulphite | According to test |
| 50 | (Ib) | Ammonium benzoate | According to test |
| 51 | (Ib) | Ammonium hydrogen oxalate | According to test |
| 52 | (Ib) | Ammonium hydrogen citrate | According to test |
| 53 | (Ib) | Tetramethylammonium sulphate | According to test |
| 54 | (Ib) | Tetramethylammonium lactate | According to test |
| 55 | (Ib) | Tetramethylammonium nitrate | According to test |
| 56 | (Ib) | Tetramethylammonium | According to test |
| | | thiosulphate | |
| 57 | (Ib) | Tetramethylammonium thiocyanate | According to test |
| 58 | (Ib) | Tetramethylammonium citrate | According to test |
| 59 | (Ib) | Tetramethylammonium oxalate | According to test |
| 60 | (Ib) | Tetramethylammonium formate | According to test |
| 61 | (Ib) | Tetramethylammonium hydrogen | According to test |
| | | phosphate | |
| 62 | (Ib) | Tetramethylammonium dihydrogen | According to test |
| | | phosphate | |
| 63 | (Ib) | Tetraethylammonium sulphate | According to test |
| 64 | (Ib) | Tetraethylammonium lactate | According to test |
| 65 | (Ib) | Tetraethylammonium nitrate | According to test |
| 66 | (Ib) | Tetraethylammonium | According to test |
| | | thiosulphate | |
| 67 | (Ib) | Tetraethylammonium thiocyanate | According to test |
| 68 | (Ib) | Tetraethylammonium citrate | According to test |
| 69 | (Ib) | Tetraethylammonium oxalate | According to test |
| 70 | (Ib) | Tetraethylammonium formate | According to test |
| 71 | (Ib) | Tetraethylammonium hydrogen | According to test |
| | | phosphate | |
| 72 | (Ib) | Tetraethylammonium dihydrogen | According to test |
| | | phosphate | |
| 73 | (Ic) | Ammonium sulphate | According to test |
| 74 | (Ic) | Ammonium lactate | According to test |
| 75 | (Ic) | Ammonium nitrate | According to test |
| 76 | (Ic) | Ammonium thiosulphate | According to test |
| 77 | (Ic) | Ammonium thiocyanate | According to test |
| 78 | (Ic) | Ammonium citrate | According to test |
| 79 | (Ic) | Ammonium oxalate | According to test |
| 80 | (Ic) | Ammonium formate | According to test |
| 81 | (Ic) | Ammonium hydrogen phosphate | According to test |
| 82 | (Ic) | Ammonium dihydrogen phosphate | According to test |
| 83 | (Ic) | Ammonium carbonate | According to test |
| 84 | (Ic) | Ammonium benzoate | According to test |
| 85 | (Ic) | Ammonium sulphite | According to test |
| 86 | (Ic) | Ammonium benzoate | According to test |
| 87 | (Ic) | Ammonium hydrogen oxalate | According to test |
| 88 | (Ic) | Ammonium hydrogen citrate | According to test |
| 89 | (Ic) | Tetramethylammonium sulphate | According to test |
| 90 | (Ic) | Tetramethylammonium lactate | According to test |
| 91 | (Ic) | Tetramethylammonium nitrate | According to test |
| 92 | (Ic) | Tetramethylammonium | According to test |
| | | thiosulphate | |
| 93 | (Ic) | Tetramethylammonium thiocyanate | According to test |
| 94 | (Ic) | Tetramethylammonium citrate | According to test |
| 95 | (Ic) | Tetramethylammonium oxalate | According to test |
| 96 | (Ic) | Tetramethylammonium formate | According to test |
| 97 | (Ic) | Tetramethylammonium hydrogen | According to test |
| | | phosphate | |
| 98 | (Ic) | Tetramethylammonium dihydrogen | According to test |
| | | phosphate | |
| 99 | (Ic) | Tetraethylammonium sulphate | According to test |
| 100 | (Ic) | Tetraethylammonium lactate | According to test |
| 101 | (Ic) | Tetraethylammonium nitrate | According to test |
| 102 | (Ic) | Tetraethylammonium | According to test |
| | | thiosulphate | |
| 103 | (Ic) | Tetraethylammonium thiocyanate | According to test |
| 104 | (Ic) | Tetraethylammonium citrate | According to test |
| 105 | (Ic) | Tetraethylammonium oxalate | According to test |
| 106 | (Ic) | Tetraethylammonium formate | According to test |
| 107 | (Ic) | Tetraethylammonium hydrogen | According to test |
| | | phosphate | |
| 108 | (Ic) | Tetraethylammonium dihydrogen | According to test |
| | | phosphate | |

Crop protection agents according to the invention may also contain further components, for example surfactants or dispersants or emulsifiers.

Suitable nonionic surfactants or dispersants are all substances of this type which can usually be used in agrochemical agents. Polyethylene oxide-polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic acid esters, furthermore alkyl ethoxylates and alkylaryl ethoxylates which may optionally be phosphated and optionally neutralized with bases, sorbitol ethoxylates being mentioned by way of example, and polyoxyalkylenamine derivatives may preferably be mentioned.

Suitable anionic surfactants are all substances of this type which can usually be used in agrochemical agents. Alkali metal and alkaline earth metal salts of alkylsulphonic acids or alkylarylsulphonic acids are preferred.

A further preferred group of anionic surfactants or dispersants comprises salts of polystyrenesulphonic acids, salts of polyvinylsulphonic acids, salts of naphthalenesulphonic acid-formaldehyde condensates, salts of condensates of naphthalenesulphonic acid, phenolsulphonic acid and formaldehyde and salts of ligninsulphonic acid, which salts have low solubility in vegetable oil.

Suitable additives which may be present in the formulations according to the invention are emulsifiers, foam-inhibiting agents, preservatives, antioxidants, dyes and inert filling materials.

Preferred emulsifiers are ethoxylated nonylphenols, reaction products of alkylphenols with ethylene oxide and/or propylene oxide, ethoxylated arylalkylphenols, furthermore ethoxylated and propoxylated arylalkylphenols, and sulphated or phosphated arylalkyl ethoxylates or ethoxypropoxylates, sorbitan derivatives, such as polyethylene oxide sorbitan fatty acid ester and sorbitan fatty acid ester, being mentioned by way of example.

### EXAMPLE

### Spodoptera frugiperda—Test (SPODFR)

| | |
|---|---|
| Solvent: | 7 parts by weight of dimethylformamide |
| Emulsifier: | 10 parts by weight of alkylaryl polyglycol ether |

For the preparation of an expedient active ingredient preparation, 1 part by weight of active ingredient is mixed with the stated amounts of solvent and emulsifier, and the concentrate is diluted with emulsifier-containing water to the desired concentration. If it is necessary to add ammonium salts or ammonium salts and penetration promoter, the corresponding amount is pipetted into each of the ready preparation solution after the dilution.

Maize plants (Zea mais) are treated with the active ingredient preparation in the desired concentration by spraying and are populated with caterpillars of the fall armyworm (Spodoptera frugiperda) as long as the leaves are still moist.

After the desired time, the kill in % is determined. 100% means that all caterpillars were killed; 0% means that no caterpillars were killed.

In this test, for example, the following compounds of the preparation examples show good efficiency: cf. table

| | | Mortality/% |
|---|---|---|
| Compound | g a.i./ha | 7 d |
| (Ib) + ammonium sulphate | 0.192 | 100 |
| according to the invention | | |
| (Ib) | 0.192 | 70 |
| Prior art | | |

1. A composition comprising:
at least one insecticidal active ingredient of formula (I) 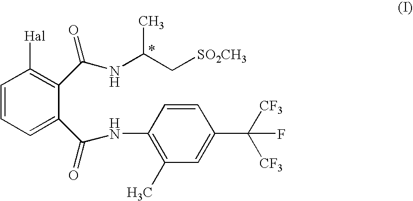
in which
Hal represents chlorine, bromine or iodine,
* is a carbon atom in the R- or the S-configuration, and
at least one salt of formula (II) 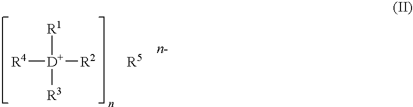
in which
D represents nitrogen or phosphorus,
R¹, R², R³ and R⁴, independently of one another, represent hydrogen or in each case optionally substituted C₁-C₈-alkyl or mono- or polyunsaturated, optionally substituted C₁-C₈-alkylene, it being possible for substituents of R¹, R², R³ and/or R⁴ to be selected from halogen, nitro and cyano,
n represents 1, 2, 3 or 4,
R⁵ represents an inorganic or organic anion.

2. Composition according to claim 1, wherein the total content of said ingredient of formula (I) is from 0.5 to 50% by weight.

3. Composition according to either of claim 1, wherein D represents nitrogen.

4. Composition according to claim 3, wherein R⁵ represents bicarbonate, tetraborate, fluoride, bromide, iodide, chloride, monohydrogen phosphate, dihydrogen phosphate, hydrogen sulphate, tartrate, sulphate, nitrate, thiosulphate, thiocyanate, formate, lactate, acetate, propionate, butyrate, pentanoate, citrate or oxalate.

5. Composition according to claim 3, wherein R⁵ represents carbonate, pentaborate, sulphite, benzoate, hydrogen oxalate, hydrogen citrate, methyl sulphate or tetrafluoroborate.

6. Composition according to claim 3, wherein R⁵ represents lactate, sulphate, nitrate, thiosulphate, thiocyanate, citrate, oxalate or formate.

7. Composition according to claim 3, wherein R⁵ represents sulphate.

8. Composition according to any of claim 1 further comprising at least one penetration promoter.

9. Composition according to claim 8, wherein the penetration promoter is (i) a fatty alcohol alkoxylate of formula (III)
R—O—(-AO)ᵥ—R′ (III)
in which
R represents straight-chain or branched alkyl having 4 to 20 carbon atoms,
R′ represents hydrogen, methyl, ethyl, n-propyl, isopropyl, n-butyl, isobutyl, tert-butyl, n-pentyl or n-hexyl,
AO represents an ethylene oxide radical, a propylene oxide radical, a butylene oxide radical or mixtures of ethylene oxide and propylene oxide radicals or butylene oxide radicals and
v represents a number from 2 to 30,
and/or (ii) a mineral or vegetable oil and/or (iii) an ester of a mineral or vegetable oil.

10. Composition according to claim 8, wherein the penetration promoter is an ester of a vegetable oil.

11. Composition according to claim 8, wherein the penetration promoter is a rapeseed oil methyl ester.

12. Composition according to claim 1, wherein the penetration promoter is present in an amount from 1 to 95% by weight.

13. A method for controlling insect pests comprising applying, a composition according to claim 1 undiluted or diluted to an insect or a habitat of an insect in an amount such that an effective amount of the insecticidal active ingredient present acts on the insect or habitat.

14. A method for increasing the action of crop protection activity comprising preparing a spray liquor comprising a composition according to claim 1.

15. Method according to claim 14, wherein the spray liquor is prepared using a penetration promoter.

16. Method according to claim 14 the salt of the formula (II) is present in a concentration of 0.5 to 80 mmol/l in said composition.

17. Method according to claim 15, wherein the penetration promoter is present in said composition in a concentration of 0.1 to 10 g/l.

18. Method according to claim 15, wherein the penetration promoter is present in said composition in a concentration of 0.1 to 10 g/l and the salt of the formula (II) in a concentration of 0.5 to 80 mmol/l.

19. A composition capable of increasing the action of a crop protection agent comprising a composition according to claim 1, in the form of a ready-to-use crop protection spray liquor agent.

20. A composition according to claim 19, wherein the salt of the formula (II) is present in the ready-to-use crop protection agent in a concentration of 0.5 to 80 mmol/l.

21. A composition according to claim 19 further comprising a penetration promoter.

22. A composition comprising a phthalic acid diamide and at least one salt of formula (II) 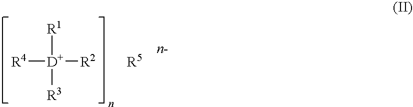
in which
D represents nitrogen or phosphorus,
R¹, R², R³ and R⁴, independently of one another, represent hydrogen or in each case optionally substituted C₁-C₈-alkyl or mono- or polyunsaturated, optionally substituted C₁-C₈-alkylene, it being possible for substituents of R¹, R², R³ and/or R⁴ to be selected from halogen, nitro and cyano,
n represents 1, 2, 3 or 4,
R⁵ represents an inorganic or organic anion.

23. A composition according to claim 1, wherein said ingredient of formula (I) comprises at least one of

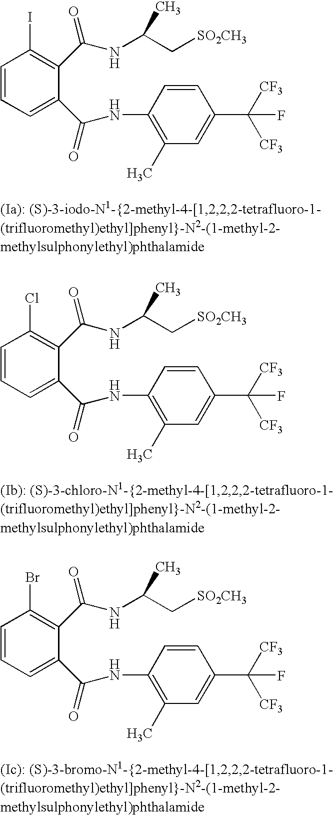

24. A composition of claim 19, wherein said ingredient of formula (I) comprises at least one of [chemical structure]
